(19) United States
(12) Patent Application Publication
(10) Pub. No.: US 2004/0142140 A1
(43) Pub. Date: Jul. 22, 2004

(54) Apparatus for protecting surfaces and protecting individuals from contaminants

(75) Inventors: Yamilia Halfon, Sugar Land, TX (US); Alina Garcia, Houston, TX (US); Irma J. Herrera, Houston, TX (US)

Correspondence Address: FULBRIGHT & JAWORSKI, LLP, 1301 MCKINNEY, SUITE 5100, HOUSTON, TX, 77010-3095, US

(73) Assignee: Home Collection, Inc., Sugar Land, TX

(21) Appl. No.: 10/345,943

(22) Filed: Jan. 16, 2003

(51) Int. Cl. B32B 3/06

(52) U.S. Cl. 428/80; 428/100

(57) ABSTRACT

The present invention provides a cloth adapted to be secured about a handle of a device such as a shopping cart or refrigerator. The cloth may be either disposable or reusable.

### TECHNICAL FIELD

The present invention relates generally to both reusable and disposable absorbent articles such as towels and cloths.

Individuals are becoming more aware of and sensitive to contaminants in their daily lives. These contaminants may include dirt, grime, bacteria, and other organisms that may accumulate on or grow on surfaces that are encountered on a daily basis. For example, in a home full of teenagers or in a automobile service station, refrigerator door handles and the like are routinely subject to dirt, grime, and stains from constant use. Cleaning refrigerator door handles under such circumstances becomes a relatively constant task, which necessitates the use of cleaning supplies and the like which may be undesirable.

In another example, some individuals are reluctant to handle items encountered on a routine basis such as shopping cart handles because they are viewed as being dirty or covered in bacteria. In addition, parents of teething children are often concerned with their child's tendency to chew on items encountered in everyday situations such as shopping cart handles. Solutions to these concerns may include wearing gloves or wiping the handles with cleaning supplies. Neither solution adequately addresses concerns associated with teething babies. In addition this require the use of undesirable chemicals or wearing uncomfortable gloves.

Accordingly, there is a need for an apparatus for protecting surfaces and protecting individuals from contaminants that may normally accumulate on surfaces that solves the shortcomings of the prior art.

### BRIEF SUMMARY OF THE INVENTION

The present invention solves the shortcomings in the prior art described above. The present invention provides an apparatus for protecting surfaces and protecting individuals from contaminants that may normally accumulate on surfaces that solves the shortcomings of the prior art.

The present invention provides a cloth that may affixed to things such as refrigerator door handles and shopping cart handles. The cloth is adapted to cover and be secured about the handle. The cloth may be manufactured by and secured with a variety of different compositions that are discussed in more detail below. Both a reusable and a disposable cloth is provided.

The present invention thus provides advantages over existing apparatus by providing novel techniques, including an apparatus for protecting surfaces and protecting individuals from contaminants that may normally accumulate on surfaces that solves the shortcomings of the prior art.

Other objects, features; advantages of the present invention will become apparent from a review of the detailed description of the preferred embodiments, including the illustrative examples and the appended claims that follow.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates an embodiment of the present invention in which a cloth is cut in a rectangular shape with attachment means located along the longitudinal sides

FIG. 2 illustrates an embodiment of the present invention in which a cloth is adapted in shape.

FIG. 3 illustrates an application of a cloth in which the cloth is secured about a refrigerator handle;

FIG. 4 illustrates an application of a cloth in which the cloth is secured about a shopping cart handle.

### DETAILED DESCRIPTION OF THE INVENTION

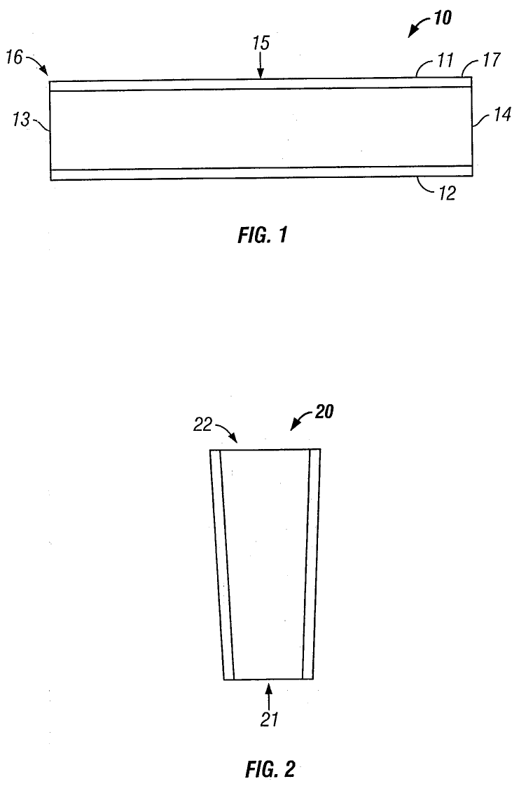

To provide a better understanding of the present invention, a detailed description of a preferred implementation is presented. The present invention is an apparatus for protecting surfaces and protecting individuals from contaminants that may normally accumulate on surfaces. A preferred embodiment of the present invention is shown in FIG. 1.

As shown in FIG. 1, cloth 10 is cut such that there is a pair of longitudinal sides 11 and 12 and latitudinal sides 13 and 14. Cloth 10 may be made of a number of commercially available materials including cotton fabrics such as terrycloth, synthetic fabrics such as polyester, disposable fabrics such as non-woven webs of natural fibers (e.g., wood or cotton), synthetic fibers (e.g., polypropylene or polyester) or a combination of such webs and fibers.

A securing element 15 is preferably affixed to either corners 16 and 17 or along longitudinal side 11. As shown in the preferred embodiment, securing element 15 comprises a hook and loop feature in which the hook feature is secured to longitudinal side 11 and the loop feature is secured to longitudinal side 12. The securing element may alternatively be an adhesive, mechanical fastener such as snaps, hook and loop features, or conceivably strings, i.e., anything that will secure one end of the article to the longitudinally opposite end.

One aspect of the present invention involves the protection of surfaces such as kitchen surfaces. More particularly, the present invention provides a means for protecting refrigerator door handles from contaminants, dirt, grime, and stain. Another aspect of the present invention involves protecting individuals and, in particular, children from contaminants located on apparatuses such as shopping cart handles.

### Exemplary Scenarios

The following scenarios are exemplary situations that may be encountered in practice in which the present invention may be used:

Refrigerators

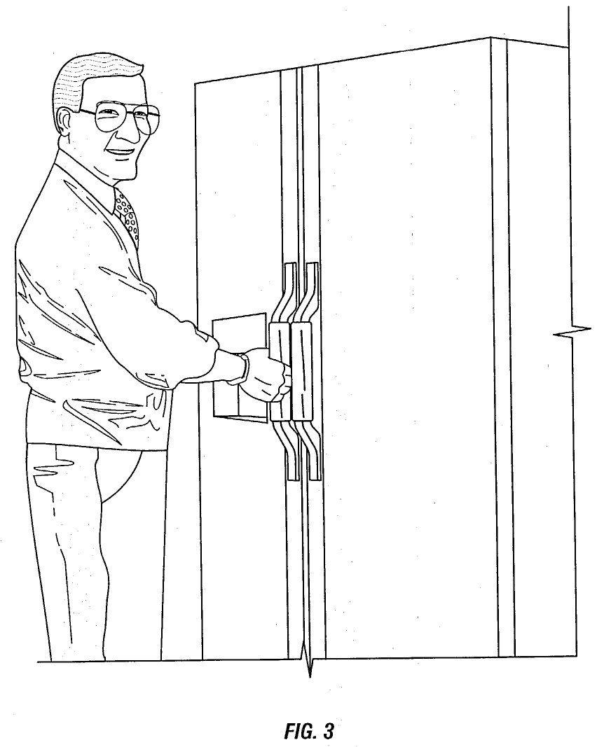

As shown in FIG. 2, cloth 20 is adapted to be secured about a refrigerator handle. In the illustrated embodiment, latitudinal side 22 is longer than latitudinal side 23. This allows cloth 20 to accommodate refrigerator handle 21 in which the base of a handle is narrower than the top of a handle. In this embodiment, cloth 20 is preferably made of a cotton material such as terrycloth, which may be routinely washed. In addition, the securing element (not shown) on cloth 21 is preferably a hook and loop device for ease of attachment and reusability. FIG. 3 illustrates cloth 20 secured to a refrigerator door handle.

Shopping Carts

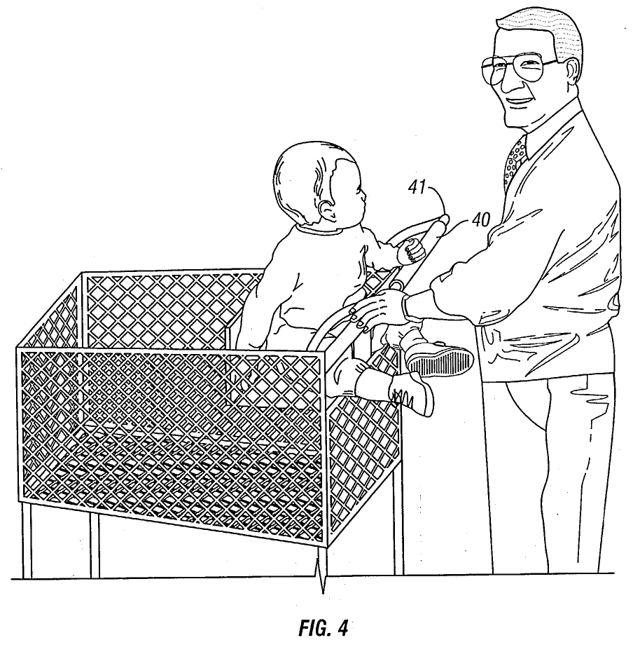

As shown in FIG. 4, cloth 40 is adapted to be secured about shopping cart handle 41. In this embodiment, cloth 40 is preferably made of a disposable material such as non-woven webs of natural fibers (e.g., wood or cotton) or synthetic fibers (e.g., polypropylene or polyester), a combination of such webs or fibers. This would permit a store to provide a disposable supply of cloths 40 to its patrons. The securing element (not shown) on cloth 41 is preferably a hook and loop device or adhesive for ease of attachment.

Alternatively, cloth 40 may be a reusable fabric such as terrycloth that is affixed by hook and loop devices. This permits a consumer to reuse cloth 40 and periodically wash cloth 30.

The cloths disclosed provide a wide range of applications, including chains on swings in playgrounds, or gas pump handles, which may be encountered on a daily basis.

### Conclusion

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A cloth comprising:
Longitudinal sides;
Latitudinal sides; and
A securing means along the longitudinal sides that is adapted to secure the cloth about a handle.

2. The cloth of claim 1, wherein said cloth is manufactured from terrycloth and said securing means is manufactured from a hook and loop apparatus.

3. The cloth of claim 2, wherein one of said latitudinal sides is longer than the other, whereby said cloth may be more easily secured about an oblong handle.

4. A disposable cloth adapted to secure about a shopping cart handle comprising:
Longitudinal sides;
Latitudinal sides; and
A securing means along the longitudinal sides that is adapted to secure the cloth about a handle.

5. The cloth of claim 4, wherein said cloth is manufactured from non-woven webs of natural fibers, synthetic fibers, or a combination of natural and synthetic fibers.

6. the cloth of claim 5, wherein said securing means is either hook and loop or adhesives.

7. The cloth of claim 1, wherein said cloth is attached about a shopping cart handle.

8. The cloth of claim 1, wherein said cloth is attached about a refrigerator door handle.

9. the cloth of claim 7, wherein said cloth is manufactured from non-woven webs of natural fibers, synthetic fibers, or a combination of natural and synthetic fibers.

10. The cloth of claim 7, wherein said cloth is manufactured from terrycloth.

11. The cloth of claim 8, wherein said cloth is manufactured from non-woven webs of natural fibers, synthetic fibers or a combination of natural and synthetic fibers.

12. The cloth of claim 8, wherein said cloth is manufactured from terrycloth.
